(19) United States
(12) Patent Application Publication
(10) Pub. No.: US 2021/0110405 A1
(43) Pub. Date: Apr. 15, 2021

(54) SYSTEM AND METHOD FOR IMPLEMENTING A DATA CONTRACT MANAGEMENT MODULE

(71) Applicant: JPMorgan Chase Bank, N.A., New York, NY (US)

(72) Inventors: Alan LIGHT, New York, NY (US); Sunil NAIR, River Vale, NJ (US)

(73) Assignee: JPMorgan Chase Bank, N.A., New York, NY (US)

(21) Appl. No.: 17/066,816

(22) Filed: Oct. 9, 2020

Related U.S. Application Data
(60) Provisional application No. 62/913,018, filed on Oct. 9, 2019.

(51) Int. Cl. G06Q 30/00; G06Q 50/18; G06Q 10/10; H04L 9/32

(52) U.S. Cl. CPC G06Q 30/016; G06Q 50/18; G06Q 10/10; G06Q 2220/10; H04L 9/3263; H04L 9/3247; G06Q 30/0185

(57) ABSTRACT

A system and method for implementing a data contract management module for automatic enforcement of a data contract are disclosed. The data contract includes one or more validation rules and stored onto a repository. A processor coupled to the repository via a communication network generates a data contract compliance certificate that either indicates that all validation rules are successful, or one or more validation rules has failed. In the case one or more validations has failed, the processor also generates a digital variance certificate for each failed validation rule that explains the reason for failing and authorizes processing of the data contract in spite of one or more failed validation rules.

### CROSS-REFERENCE TO RELATED APPLICATIONS

This application claims the benefit of priority from U.S. Provisional Patent Application No. 62/913,018, filed Oct. 9, 2019, which is herein incorporated by reference in its entirety

### TECHNICAL HELD

This disclosure generally relates to data management, and, more particularly, to methods and apparatuses for implementing a data contract management module for automatic enforcement of a data contract.

### BACKGROUND

Today's corporations, agencies, institutions, and other organizations are facing a continuing problem of handling and processing a vast amount of data in a quick and expedited manner and managing quality of data received. The vast amount of data often received on a daily basis may be now stored electronically and may need to be analyzed by a variety of persons within the organization relative, to business or organizational goals. The need to determine efficiently what data may be available for analysis and how to manage quality of data received across organizational management boundaries to process data in an expedited manner may prove to be extremely time consuming and confusing as the data being tracked increases and no tools to determine whether the received data is approved by an authorized data provider for further processing.

### SUMMARY

The present disclosure, through one or more of its various aspects, embodiments, and/or specific features or sub-components, provides, among other features, various systems, servers, devices, methods, media, programs, and platforms for implementing a data contract management module that allows automatic enforcement of a data contract that may exist between a data provider and a data consumer without requiring any need to contact the data provider thereby significantly increasing data processing speed and significantly reducing lapse time that may be necessary to manage data quality of data that is flowing between a plurality of computing devices, but the disclosure is not limited thereto,

According to an aspect of the present disclosure, a method for implementing a data contract management module for automatic enforcement of a data contract by utilizing one or more processors and one or more memories is disclosed. The method may include: receiving, by a computing device, a data contract that exists between a data provider and a data consumer, the data contract including one or more validation rules; determining, by the computing device, whether the one or more validation rules in the data contract complies with predefined compliance rules; responsive to determining that all validation rules in the data contract comply with the predefined compliance rules, causing a processor to perform the following: generating a digital data contract compliance certificate; digitally attaching the digital data contract compliance certificate with the data contract and transmitting the data contract along with the attached digital data contract compliance certificate to an output device for automatic processing for enforcement of the data contract; and responsive to determining that one or more validation rules in the data contract fails to comply with the predefined compliance rules, causing the processor to perform the following: generating a partial digital data. contract compliance certificate; generating a digital variance certificate for each failed validation rule that explains reason for failing; authorizing processing of the data contract in spite of one or more failed validation rules; digitally attaching the partial digital data contract compliance certificate and the digital. variance certificate with the data contract and transmitting the data contract along with the partial digital data contract compliance certificate and the digital variance certificate to an output device, for automatic processing for enforcement of the data contract.

According to another aspect of the present disclosure, instead of digitally attaching the partial digital data contract compliance certificate and the digital variance certificate with the data contract and transmitting the data contract along with the partial digital data contract compliance certificate and the digital variance certificate to an output device, other methods may also be implemented to make the partial digital data contract compliance certificate and the digital variance certificate available for users' access. For example, according to an exemplary embodiment, a likely use case may involve storing the partial digital data contract compliance certificate and the digital variance certificate onto a repository and providing access to the repository for accessing the partial digital data contract compliance certificate and the digital variance certificate by both the data provider and the data consumer via an application processing interface (API), but the disclosure is not limited thereto.

According to a further aspect of the present disclosure, the generating a digital data contract compliance certificate may further include: indicating that the authorized data provider is an individual authorized to take responsibility that all validation rules in the data contract comply with the predefined compliance rules. According to exemplary embodiments, such indication may optionally be provided by cryptographically signing, with the computing device, the digital data contract compliance certificate with an authorized data provider's private key, but the disclosure is not limited thereto.

According to yet another aspect of the present disclosure, the generating a partial digital data contract compliance certificate may further include: indicating that the authorized data provider is an individual authorized to take responsibility that the authorized data provider is an individual authorized to take responsibility that one or more validation rules in the data contract fails to comply with the predefined compliance rules. According to exemplary embodiments, such indication may optionally be provided by cryptographically signing, with the computing device, the partial digital data contract compliance certificate with an authorized data provider's private key, but the disclosure is not limited thereto.

According to another aspect of the present disclosure, the generating a digital variance certificate may further include: indicating that the authorized data provider is an individual authorized to take responsibility for data contract variances. According to exemplary embodiments, such indication may optionally be provided by cryptographically signing, with the computing device, each digital variance certificate with an authorized data provider's private key, but the disclosure is not limited thereto.

According to a further aspect of the present disclosure, the authorizing processing of the data contract in spite of one or more failed validation rules may further include: indicating that the authorized data provider is an individual authorized to take responsibility for authorizing processing of the data contract in spite of one or more failed validation rules. According to exemplary embodiments, such indication may optionally be provided by cryptographically signing, with the computing device, each digital variance certificate with an authorized data provider's private key, but the disclosure is not limited thereto.

According to yet another aspect of the present disclosure, the digital data contract compliance certificate may indicate a status of a group of validations which constitute the digital data contract.

According to a further aspect of the present disclosure, the output device may be utilized by the data consumer, and the method may further include: receiving, by the output device, the data contract along with the attached digital data contract compliance certificate; and automatically processing the data contract for enforcement of the data contract without requiring any need to contact the data provider.

According to an additional aspect of the present disclosure, the output device may be utilized by a data consumer, and the method may further include: receiving, by the output device, the data contract along with the partial digital data contract compliance certificate and the digital variance certificate; and automatically processing the data contract for enforcement of the data contract without requiring any need to contact the data provider.

According to another aspect of the present disclosure, a system for implementing a data contract management module for automatic enforcement of a data contract is disclosed. The system may include: a repository that digitally stores a data contract that exists between a data provider and a data consumer, the data contract including one or more validation rules; and a processor coupled to the repository via a communication network, wherein the processor may be configured to: determine whether the one or more validation rules in the data contract complies with predefined compliance rules; responsive to determining that all validation rules in the data contract comply with the predefined compliance rules, the processor may be further configured to: generate a digital data contract compliance certificate; digitally attach the digital data contract compliance certificate with the data contract; and transmit the data contract along with the attached digital data contract compliance certificate to an output device for automatic processing for enforcement of the data contract; and responsive to determining that one or more validation rules in the data contract fails to comply with the predefined compliance rules, the processor may be further configured to: generate a partial digital data contract compliance certificate; generate a digital variance certificate for each failed validation rule that explains the reason for failing; authorize processing of the data contract in spite of one or more failed validation rules; digitally attach the partial digital data contract compliance certificate and the digital variance certificate with the data contract; and transmit the data contract along with the partial digital data contract compliance certificate and the digital variance certificate to an output device for automatic processing for enforcement of the data contract.

According to a further aspect of the present disclosure, in generating a digital data contract compliance certificate, the processor may be further configured to: indicate that the authorized data provider is an individual authorized to take responsibility that all validation rules in the data contract comply with the predefined compliance rules. According to exemplary embodiments, such indication may optionally be provided by cryptographically signing, with the computing device, the digital data contract compliance certificate with an authorized data provider's private key, but the disclosure is not limited thereto.

According to yet another aspect of the present disclosure, in generating a partial digital data contract compliance certificate, the processor may be further configured to: indicate that the authorized data provider is an individual authorized to take responsibility that the authorized data provider is an individual authorized to take responsibility that one or more validation rules in the data contract fails to comply with the predefined compliance rules. According, to exemplary embodiments, such indication may optionally be provided by cryptographically signing, with the computing device, the partial digital data contract compliance certificate with an authorized data provider's private key, but the disclosure is not limited thereto.

According to another aspect of the present disclosure, in generating a digital variance certificate, the processor may be further configured to: indicate that the authorized data provider is an individual authorized to take responsibility for data contract variances. According to exemplary embodiments, such indication may optionally be provided by cryptographically signing, with the computing device, each digital variance certificate with an authorized data provider's private key, but the disclosure is not limited thereto.

According to a further aspect of the present disclosure, in authorizing processing of the data contract in spite of one or more failed validation rules, the processor may be further configured to: indicate that the authorized data provider is an individual authorized to take responsibility for authorizing processing of the data contract in spite of one or more failed validation rules. According to exemplary embodiments, such indication may optionally be provided by cryptographically signing, with the computing device, each digital variance certificate with an authorized data provider's private key, but the disclosure is not limited thereto.

According to yet another aspect of the present disclosure, the output device may be utilized by the data consumer, and the processor may be further configured to: cause the output device to receive the data contract along with the attached digital data contract compliance certificate; and automatically process the data contract for enforcement of the data contract without requiring any need to contact the data provider.

According to an additional aspect of the present disclosure, the output device may be utilized by a data consumer, and the processor may be further configured to: cause the output device to receive the data contract along with the partial digital data contract compliance certificate and the digital variance certificate; and automatically process the data contract for enforcement of the data contract without requiring, any need to contact the data provider.

According to yet another aspect of the present disclosure, a non-transitory computer readable medium configured to store instructions for implementing a data contract management module for automatic enforcement of a data contract is disclosed. The instructions, when executed, may cause a processor to perform the following: receiving, by a computing device, a data contract that exists between a data provider and a data consumer, the data contract including one or more validation rules; determining, by the computing device, whether the one or more validation rules in the data contract complies with predefined compliance rules; responsive to determining that all validation rules in the data contract comply with the predefined compliance rules, causing the processor to perform the following: generating a digital data contract compliance certificate; digitally attaching the digital data contract compliance certificate with the data contract; and transmitting, the data contract along with the attached digital data contract compliance certificate to an output device for automatic processing for enforcement of the data contract; and responsive to determining that one or more validation rules in the data contract fails to comply with the predefined compliance rules, causing the processor to perform the following: generating a partial digital data contract compliance certificate; generating a digital variance certificate for each failed validation rule that explains the reason for failing; authorizing processing of the data contract in spite of one or more failed validation rules; digitally attaching the partial digital data contract compliance certificate and the digital variance certificate with the data contract; and transmitting the data contract along with the partial digital data contract compliance certificate and the digital variance certificate to an output device for automatic processing for enforcement of the data contract.

According to a further aspect of the present disclosure, in generating a digital data contract compliance certificate, the instructions, when executed, may cause the processor to further perform: indicating that the authorized data provider is an individual authorized to take responsibility that all validation rules in the data contract comply with the predefined compliance rules. According to exemplary embodiments, such indication may optionally be provided by cryptographically signing, with the computing device, the digital data contract compliance certificate with an authorized data provider's private key but the disclosure is not limited thereto.

According to yet another aspect of the present disclosure, in generating a partial digital data contract compliance certificate, the instructions, when executed, may cause the processor to further perform: indicating that the authorized data provider is an individual authorized to take responsibility that the authorized data provider is an individual authorized to take responsibility that one or more validation rules in the data contract fails to comply with the predefined compliance rules. According to exemplary embodiments, such indication may optionally be provided by cryptographically signing, with the computing device, the partial digital data contract compliance certificate with an authorized data provider's private key, but the disclosure is not limited thereto.

According to another aspect of the present disclosure, in generating a digital variance certificate, the instructions, when executed, may cause the processor to further perform: indicating that the authorized data provider is an individual authorized to take responsibility for data contract variances. According to exemplary embodiments, such indication may optionally be provided by cryptographically signing, with the computing device, each digital variance certificate with an authorized data provider's private key, but the disclosure is not limited thereto.

According to a further aspect of the present disclosure, in authorizing processing of the data contract in spite of one or more failed validation rules, the instructions, when executed, may cause the processor to further perform: indicating that the authorized data provider is an individual authorized to take responsibility for authorizing processing, of the data contract in spite of one or more failed validation rules. According to exemplary embodiments. such indication may optionally be provided by cryptographically signing, with the computing device, each digital variance certificate with an authorized data provider's private key, but the disclosure is not limited thereto.

According to a further aspect of the present disclosure, the output device may be utilized by the data consumer, and the instructions, when executed, may cause the processor to further perform: receiving, by the output device, the data contract along with the attached digital data contract compliance certificate: and automatically processing the data contract for enforcement of the data contract without requiring any need to contact the data provider.

According to an additional aspect of the present disclosure, the output device may be utilized by a data consumer, and the instructions, when executed, may cause the processor to further perform: receiving, by the output device, the data contract along with the partial digital data contract compliance certificate and the digital variance certificate: and automatically processing the data contract for enforcement of the data contract without requiring any need to contact the data provider.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a data contract management module in accordance with an exemplary embodiment.

FIG. 2 illustrates an exemplary diagram of a network environment with a data contract management module in accordance with an exemplary embodiment.

FIG. 3 illustrates a system diagram for implementing a data contract management module in accordance with an exemplary embodiment.

FIG. 4A illustrates a graphical user interface (GUI) depicting a data contract in accordance with an exemplary embodiment.

FIG. 4B illustrates another graphical user interface (GUI) depicting a data contract in accordance with an exemplary embodiment.

FIG. 5 illustrates a flow chart of a process for implementing a data contract management module in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which ma be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

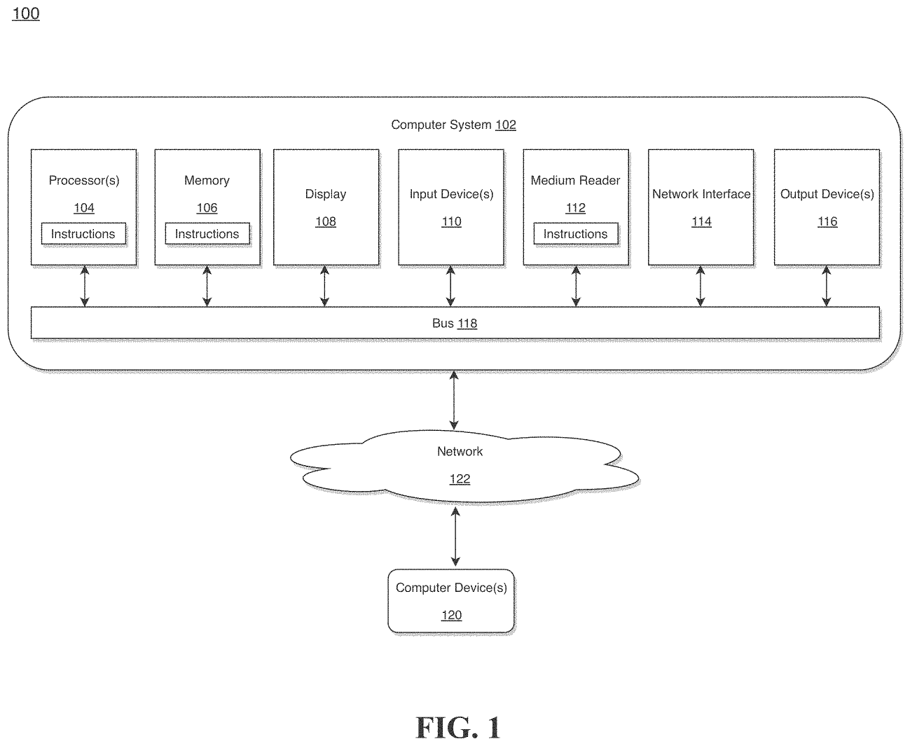

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1. the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (CPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, (Insecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display

The computer system 102 may also include at least one input device 110 such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, die medium reader 112 and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus, Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

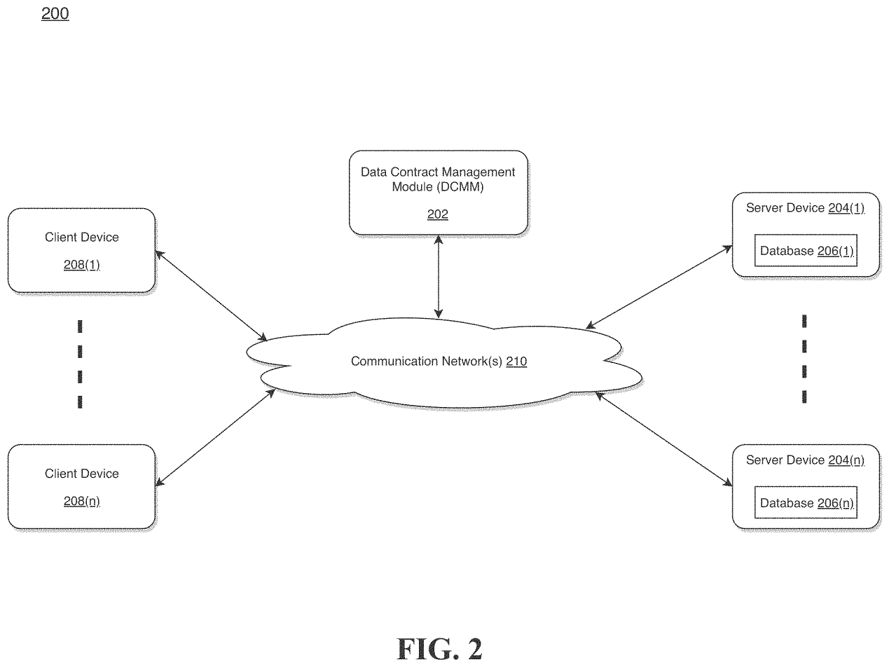

Referring to FIG. 2, a schematic of an exemplary network environment 200 for implementing a data contract management module (DCMM) of the instant disclosure is illustrated.

Conventional system, that does not implement an DCMM of the instant disclosure, may not be able to automatically handle and process a vast amount of data in a quick and expedited manner and manage quality of data received, leading to wasting computer resources and a significant delay in processing data flowing between a plurality of computing devices.

According to exemplary embodiments, the above-described problems associated with conventional approach of generating presentations may be overcome by implementing art DCMM 202 as illustrated in HG. 2 that may provide a platform for implementing the DCMM 202 which may automatically handle and process a vast amount of data in a quick and expedited manner and manage quality of data received, thereby significantly increasing data processing speed and significantly reducing lapse time that may be necessary to manage data quality of data that is flowing between a plurality of computing devices, but the disclosure is not limited thereto.

For example, the various aspects, embodiments, and/or specific features or sub-components of the instant disclosure, provide, among other features, various systems, servers, devices, methods, media, programs, and platforms for implementing a data contract management module for automatic enforcement of a data contract to significantly increase data processing speed and significantly reduce lapse time that may be necessary to manage data quality of data that is flowing between a plurality of computing devices thereby improving computer functionalities of a graphical user interface (GUI), significantly reducing utilization of computer resources, and reducing utilization of memory spaces thereby maintaining optimum memory spaces for other computer processing algorithms, but the disclosure is not limited thereto.

The DCMM 202 may be the same or similar to the computer system 102 as described with respect to FIG. 1.

The DCMM 202 may store one or more applications that can include executable instructions that, when executed by the DCMM 202, cause the DCMM 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DCMM 202 itself, may be located in virtual server(s) running in a cloud-based computing environment rather than being tied to one or more specific physical network computing devices. Also, the application(s) may be running in one or more virtual machines (VMs) executing on the DCMM 202. Additionally, in one or more embodiments of this technology, virtual machine(s) running on the DCMM 202 may be managed or supervised by a hypervisor.

In the network environment 200 of FIG. 2, the DCMM 202 is coupled to a plurality of server devices 204(1)-204(n) that hosts a plurality of databases 206(1)-206(n) including adaptive data storages, and also to a plurality of client devices 208(1)-208(n) via communication network(s) 210. A communication interface of the DCMM 202, such as the network interface 114 of the computer system 102 of FIG. 1. operatively couples and communicates between the DCMM 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DCMM 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication networks) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DCMM 202 may be a standalone device or integrated with one or more other devices or apparatuses, such as one or more of the server devices 204(1)-204(n), for example. In one particular example, the DCMM 202 may be hosted by one of the server devices 204(1)-204(n), and other arrangements are also possible. Moreover, one or more of the devices of the DCMM 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DCMM 202 via the communication network(s) 210 according to the HTTP-based, HTTPS-based, and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204M-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example.. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the DCMM 202 that may efficiently provide a platform for implementing the DCMM 202 which may be configured to automatically handle and process a vast amount of data in a quick and expedited manner and manage quality of data received, thereby significantly increasing data processing speed and significantly reducing lapse time that may be necessary to manage data quality of data that is flowing between a plurality of computing devices, but the disclosure is not limited thereto.

The client devices 208(1)-208(n) may run interface applications, such as standard web browsers or standalone client applications, which may provide an interface to communicate with the DCMM 202 via the communication networks) 210 in order to communicate user requests. The client devices 208(1)-208(n) may further include, among other features, a display device, such as a display screen or touchscreen, and/or an input device, such as a keyboard, for example.

Although the exemplary network environment 200 with the DCMM 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DCMM 202, the server devices 204(1)-204(n), or the client devices 208(1)-208(n), for example, may be configured to operate as virtual instances on the same physical machine. For example, one or more of the DCMM 202, the server devices 204(1)-204(n), or the client devices 208(1)-208(n) may operate on the same physical device rather than as separate devices communicating through communication network(s) 210. Additionally, there may be more or fewer DCMMs 202, server devices 204(1)-204(n), or client devices 208(1)-208(n) than illustrated in FIG, 2. According to exemplary embodiments, the DCMM 202 may be configured to send code at run-time to remote server devices 204(1)-204(n), but the disclosure is not limited thereto.

In addition. two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

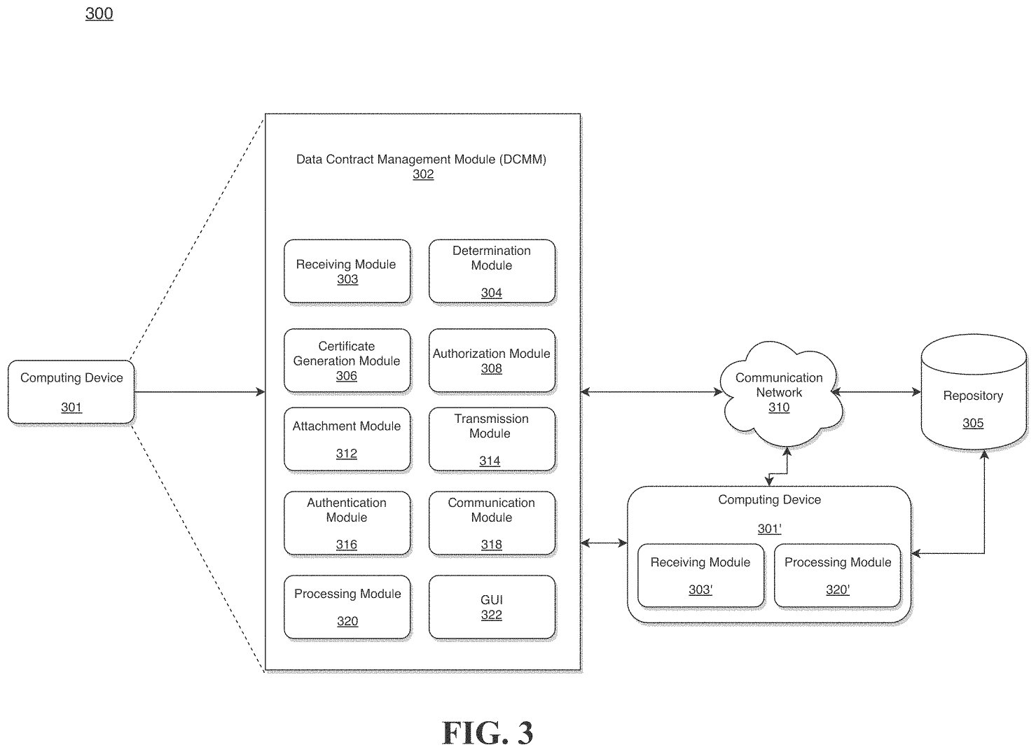

FIG. 3 illustrates a system diagram for implementing a data contract management module (DCMM) in accordance with an exemplary embodiment. According to exemplary embodiments, a system 300 is described and shown in FIG. 3 as including a DCMM 302 embedded within a computing device 301, although it may include other rules, policies, modules, databases, or applications, for example. Although FIG. 3 illustrates only one computing device 301, according to exemplary embodiments, a plurality of computing devices 301 may be provided one of which may be operated by a data provider and another one may be operated by a data consumer.

As will be described below, according to exemplary embodiments, the DCMM 302 may be configured to automatically handle and process a vast amount of data in a quick and expedited manner and manage quality of data received, thereby significantly increasing data processing, speed and significantly reducing lapse time that may be necessary to manage data quality of data that is flowing between a plurality of computing device(s) 301, but the disclosure is not limited thereto.

As shown in FIG. 3, an exemplary system 300 may include a computing device 301 within which the DCMM 302 may be embedded, a repository (i.e., database) 305 which may store a data contract that may exist between a data provider and a data consumer, and a communication network 310 via which the computing device 301, the DCMM 302, and the repository 305 are interconnected to exchange data.

According to exemplary embodiments, the computing device 301 may be the same or equivalent to the computing device 208 as illustrated in FIG. 2, the repository 305 may include a memory (e.g., shown in FIG. 1) and may be the same or equivalent to the server 204 as illustrated in FIG. 2, and the communication network 310 may be the same or equivalent to the communication network 210 as illustrated in FIG. 2.

As shown in FIG. 3, the DCMM 302 may include a receiving module 303, a determination module 304 a certificate generation module 306, an authorization module 308, an attachment module 312, a transmission module 314, an authentication module 316, a communication module 318, a processing module 320, and a graphical user interface (GUI)

The process may be executed via the communication network 310, which may comprise plural networks as described above. For example, in an exemplary embodiment, the various components of the DCMM 302 may communicate with the repository 305 via the communication module 318 and the communication network(s) 310. Of course, these embodiments are merely exemplary and are not limiting or exhaustive.

According to exemplary embodiments, each of the receiving module 303, the determination module 304, the certificate generation module 306, the authorization module 308, the attachment module 312, the transmission module 314, the authentication module 316, the communication module 318, and the processing module 320 may be implemented by microprocessors or similar, they may be programmed using software (e.g., microcode) to perform various functions discussed herein and may optionally be driven by firmware and/or software. Alternatively, each of the receiving module 303. the determination module 304, the certificate generation module 306, the authorization module 308, the attachment module 312, the transmission module 314, the authentication module 316, the communication module 318, and the processing module 320 may be implemented by dedicated hardware, or as a combination of dedicated hardware to perform some functions and a processor (e.g., one or more programmed microprocessors and associated circuitry) to perform other functions without departing from the scope of the present disclosure.

According to exemplary embodiments, the repository 305 may be configured to digitally store a data contract that may exist between a data provider and a data consumer. The data contract may include one or more validation rules.

According to exemplary embodiments, the receiving module 303 may he configured to receive the data contract from the repository 305 as data feed. The determination module 304 may be configured to determine whether the one or more validation rules in the data contract complies with predefined compliance rules. The predefined compliance rules may be stored in the repository 305 and the determination module 304 may access the repository 305 to compare validation rules with the predefined compliance rules and determine, based on comparing, whether each validation rules meet a certain threshold.

For example, according to exemplary embodiments, threshold may he generated based on materiality information of data received which may define that the materiality information may not be exceed by certain percentage per day, e.g., 10%, but the disclosure is not limited thereto.

According to exemplary embodiments, threshold may also be generated based setting a number value for a size of data volume that may be obtained per day, but the disclosure is not limited thereto. For example, threshold may indicate that the size of data volume may be at least number of records and not more than y number of records, where x and y represent positive integers.

According to exemplary embodiments, threshold may also be generated based setting a particular net balance of particular set of data feed accessed from the repository 305.

According to exemplary embodiments, threshold may also be generated based indicating that a particular set of legal entities may always be represented on the data feed accessed from the repository 305.

According to exemplary embodiments, responsive to determining by the determination module 304 that all validation rules in the data contract comply with the predefined compliance rules, the certificate generation module 306 may be configured to generate a digital data contract compliance certificate. The attachment module 312 may be configured to digitally attach the digital data contract compliance certificate generated by the certificate generation module 306 with the data contract. The transmission module 314 may be configured to transmit the data contract along with the attached digital data contract compliance certificate to an output device (e.g., another computing device 301′ operated by a data consumer) for automatic processing for enforcement of the data contract.

According to another aspect of the present disclosure, instead of digitally attaching the partial digital data contract compliance certificate and the digital variance certificate with the data contract and transmitting the data contract along with the partial digital data contract compliance certificate and the digital variance certificate to an output device, other methods may also be implemented to make the partial digital data contract compliance certificate and the digital variance certificate available for users' access. For example, according to an exemplary embodiment, a likely use case may involve storing the partial digital data contract compliance certificate and the digital variance certificate onto a repository 305 and providing access to the repository 305 for accessing the partial digital data contract compliance certificate and the digital variance certificate by both the data provider and the data consumer via an application processing interface (API), but the disclosure is not limited thereto.

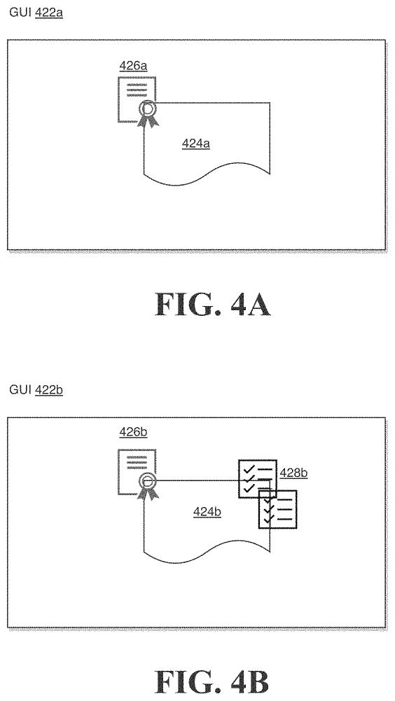

FIG. 4A illustrates a graphical user interface (GUI) depicting a data contract in accordance with an exemplary embodiment. As illustrated in FIG. 4A, the output device may include a GUI 422a that illustrates an exemplary data contract 424a along with an attached digital data contract compliance certificate 425a generated by the certificate generation module 306. The presence of this digital data contract compliance certificate 426a may provide an electronic indication that all validation rules in the data contract are fully complied with the predefined compliance rules, and therefore, configured to be automatically enforced without requiring any need to contact (e.g., sending electronic inquiry) the data provider who provided the data feed of the data contract to the data consumer.

According to exemplary embodiments, responsive to determining by the determination module 304 that one or more validation rules in the data contract fails to comply with the predefined compliance rules, the certificate generation module 306 may he configured to generate a partial digital data contract compliance certificate and a digital variance certificate for each failed validation rule that explains the reason for failing. The authorization module 308 may be configured to authorize processing of the data contract in spite of one or more failed validation rules and the attachment module 312 may be configured to digitally attach the partial digital data contract compliance certificate and the digital variance certificate, both of which are generated by the certificate generation module 306, with the data contract. According to exemplary embodiments, the transmission module 314 may be configured to transmit the data contract along with the partial digital data contract compliance certificate and the digital variance certificate to an output device (e.g., another computing device 301′ operated by a data consumer) for automatic processing for enforcement of the data contract.

FIG. 4B illustrates another graphical user interface (GUI) depicting a data contract in accordance with an exemplary embodiment. As illustrated in FIG. 4B, the output device may include a GUI 422b that illustrates an exemplary data contract 424b along with an attached patial digital data contract compliance certificate 426b and one or more digital variance certificate(s) 428b generated by the certificate generation module 306. The presence of this partial digital data contract compliance certificate 426a and the digital variance certificate(s) 428b may provide an electronic indication that although one or more validation rules in the data contract failed to comply with the predefined compliance rules, the data contract is configured to be automatically enforced without requiring any need to contact (e.g., sending electronic inquiry) the data provider who provided the data feed of the data contract to the data consumer.

Referring to FIGS. 3 and 4A, according to exemplary embodiments, in generating a digital data contract compliance certificate 426a by the certificate generation module 306, the authentication module 316 may be configured to provide cryptographical signature on the digital data contract compliance certificate 426a with an authorized data provider's private key Thus, the digital data contract compliance certificate 426a generated by the certificate generation module 306 may comprise an electronic indication that the authorized data provider is an individual authorized to take responsibility that all validation rules in the data contract 424a complies with the predefined compliance rules.

Referring to FIGS. 3 and 4B, according to exemplary embodiments, in generating a partial digital data contract compliance certificate 426b by the certificate generation module 306, the authentication module 316 may be configured to provide cryptographical signature on the partial digital data contract compliance certificate 426b with an authorized data provider's private key. Thus, the partial digital data contract compliance certificate 425b generated by the certificate generation module 306 may comprise an electronic indication that the authorized data provider is an individual authorized to take responsibility that one or more validation rules in the data contract 424b fails to comply with the predefined compliance rules.

Referring to FIGS. 3 and 4B, according to exemplary embodiments, in generating a digital variance certificate 428b by the certificate generation module 306, the authentication module 316 may be configured to provide cryptographical signature on each digital variance certificate 428b with an authorized data provider's private key. Thus, the digital variance certificates 426b generated by the certificate generation module 306 may comprise an electronic indication that the authorized data provider is an individual authorized to take responsibility for data contract variances.

Referring to FIGS. 3 and 4B, according to exemplary embodiments, in authorizing processing of the data contract 424b in spite of one or more failed validation rules by the authorization module 308, the authentication module 316 may be configured to provide cryptographical signature on each digital variance certificate 428b with an authorized data provider's private key. Thus, the digital variance certificate 428b generated by the certificate generation module 306 may provide an electronic indication that the authorized data provider is an individual authorized to take responsibility for authorizing processing of the data contract 424b in spite of one or more failed validation rules.

Although cryptographical signatures and private keys are described herein for authenticating an electronic document, the disclosure is not limited thereto. For example, other known forms of electronic authentication may be utilized to authenticate the digital data contract compliance certificate, the partial digital data contract compliance certificate, and the digital variance certificates.

According to exemplary embodiments, the digital data contract compliance certificate 426a may indicate a status of a group of validations which constitute the digital data contract 424a.

Referring to both FIGS. 3 and 4A, according to exemplary embodiments, the output device (e.g., a computing device 30F in the data consumer side) may be utilized by the data consumer. A receiving module 303′ similar to the receiving module 303 embedded within the computing device 301′ in the data consumer side may be configured to receive the data contract 424a along with the attached digital data contract compliance certificate 426a generated by the certificate generation module 306. A processing module 320′ embedded within the computing device 301′ in the data consumer side may be configured to automatically process the data contract 424a for enforcement of the data contract 424a Without requiring any need to send any inquiries to the computing device 301 in the data provider side.

Referring to both FIGS. 3 and 4B, according to exemplary embodiments, the output device (e.g., a computing device 301′ in the data consumer side) may be utilized by the data consumer. A receiving module 303′ similar to the receiving module 303 embedded within the computing device 301′ in the data consumer side may be configured to receive the data contract 424b along with the partial digital data contract compliance certificate 426b and the digital variance certificate 428b. A processing module 320′ embedded within the computing device 30F in the data consumer side may be configured to automatically process the data contract 424b for enforcement of the data contract 424b without requiring any need to send any inquiries to the computing device 301 in the data provider side.

According to exemplary embodiments, the computing device 301 may include a memory (e.g., a memory 106 as illustrated in FIG. 1) which may be a non-transitory computer readable medium that may be configured to store instructions for implementing DCMM 302 for automatic enforcement of a data contract. The computing device 301 may also include a medium reader (e.g., a medium reader 112 as illustrated in FIG. 1) which may be configured to read any one or more sets of instructions, e.g., software, from any of the memories described herein. The instructions, when executed by a processor embedded within the DCMM 302 or within the computing device 301, may be used to perform one or more of the methods and processes as described herein. In a particular embodiment, the instructions may reside completely, or at least partially, within the memory 106, the medium reader 112, and/or the processor 110 (see FIG. 1) during execution by the computing device 301.

For example, the instructions, when executed, may cause the processor 110 to perform the following: receiving, by a computing device, a data contract that exists between a data provider and a data consumer, the data contract including one or more validation rules; determining, by the computing device, whether the one or more validation rules in the data contract complies with predefined compliance rules; responsive to determining that all validation rules in the data contract comply with the predefined compliance rules, causing the processor to perform the following: generating a digital data contract compliance certificate; digitally attaching the digital data contract compliance certificate with the data contract; and transmitting the data contract along with the attached digital data contract compliance certificate to an output device for automatic processing for enforcement of the data contract; and responsive to determining that one or more validation rules in the data contract fails to comply with the predefined compliance rules, causing the processor to perform the following: generating a partial digital data contract compliance certificate; generating a digital variance certificate for each failed validation rule that explains the reason for failing; authorizing processing of the data contract in spite of one or more failed validation rules; digitally attaching the partial digital data contract compliance certificate and the digital variance certificate with the data contract; and transmitting the data contract along with the partial digital data contract compliance certificate and the digital variance certificate to an output device for automatic processing for enforcement of the data contract.

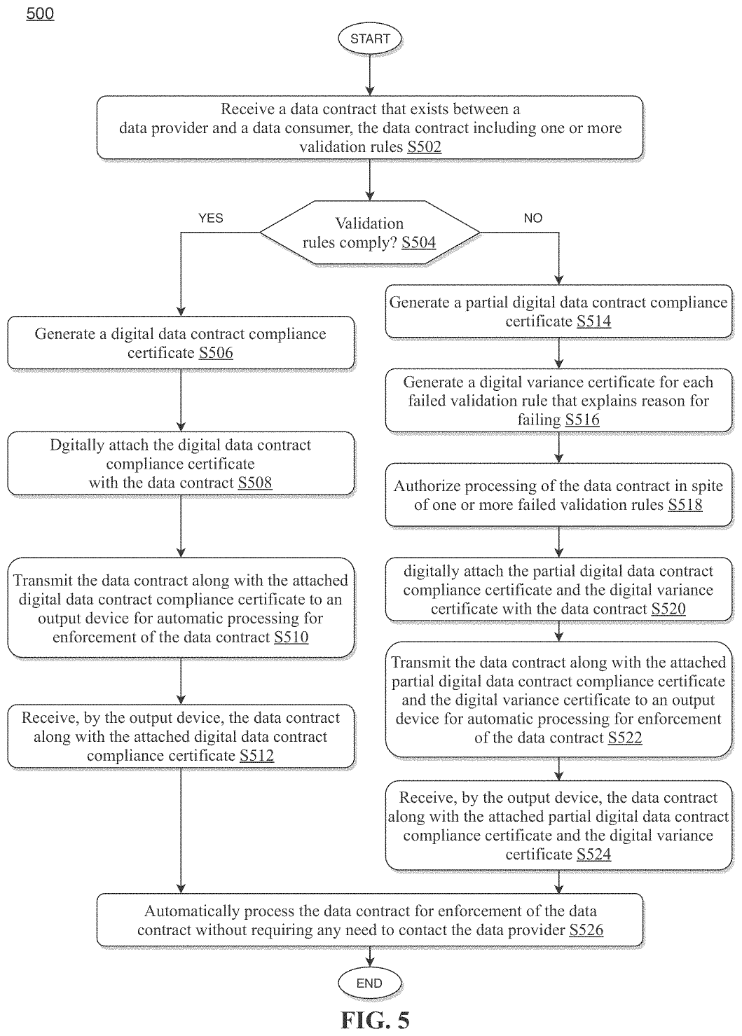

FIG. 5 illustrates a flow chart of a process 500 for implementing a data contract management module for automatic enforcement of a data contract by utilizing one or inure processors and one or more memories in accordance with an exemplary embodiment. The data contract management module may be the DCMM 302 as illustrated in FIG. 3.

At step S502, a receiver may receive a data contract that may exist between a data provider and a data consumer. The data contract may include one or more validation rules. According to exemplary embodiments, the receiver may be the same or similar to the receiving module 303 as illustrated in FIG. 3.

At step S504, it may be determined whether the one or more validation rules in the data contract complies with predefined compliance rules.

When step S504 outputs a result indicating “YES,” it is determined that all validation rules in the data contract comply with the predefined compliance rules, and thereby executing the steps S506, S508, S510, S512, and S526 by a processor in a sequential manner.

At step S506, a digital data contract compliance certificate may be generated by a certification generation module. According to exemplary embodiments, the certification generation module may be the same or similar to the certification generation module 306 as illustrated in FIG. 3.

At step S508, the digital data contract compliance certificate may be digitally attached with the data contract, by an attachment module. According to exemplary embodiments, the attachment module may be the same or similar to the attachment module 312 as illustrated in FIG. 3.

At step S510, the data contract along with the attached digital data contract compliance certificate may be transmitted by a transmission module to an output device for automatic processing for enforcement of the data contract. According to exemplary embodiments, the transmission module may be the same or similar to the transmission module 314 as illustrated in FIG. 3.

At step S512, the data contract along with the attached digital data contract compliance certificate may be received by a receiving module embedded within a computing device at a data consumer side. According to exemplary embodiments, the receiving module may be the same or similar to the receiving module 303′ as illustrated in FIG. 3 and the computing device may be the same or similar to the computing device 301′ as illustrated in FIG. 3.

At step S526, the data contract may be automatically processed by a processing module for enforcement without requiring any need to contact the data provider. According to exemplary embodiments, the processing module may be the same or similar to the processing module 320′ as illustrated in FIG. 3.

When step S504 outputs a result indicating “NO,” it is determined that one or more validation rules in the data contract fails to comply with the predefined compliance rules, and thereby executing the steps S514, S516, S518, S520, S522, S524, and S526 by a processor in a sequential manner.

At step S514, a partial digital data contract compliance certificate may be generated by, a certification generation module. According to exemplary embodiments, the certification generation module may be the same or similar to the certification generation module 306 as illustrated in FIG. 3.

At step S516, a digital variance certificate for each failed validation rule that explains reason for failing may be generated by a certification generation module. According to exemplary embodiments, the certification generation module may be the same or similar to the certification generation module 306 as illustrated in FIG. 3.

At step S518, processing of the data contract may be authorized by an authorization module 308 in spite of one or more failed validation rules. According to exemplary embodiments, the authorization module may be the same or similar to the authorization module 308 as illustrated in FIG. 3.

At step S520, the partial digital data contract compliance certificate and the digital variance certificate may be attached to the data contract by an attachment module. According to exemplary embodiments, the attachment module may be the same or similar to the attachment module 312 as illustrated in FIG. 3.

At step S522, the data contract along with the attached partial digital data contract compliance certificate and the digital variance certificate may be transmitted by a transmission module to an output device for automatic processing for enforcement of the data contract. According to exemplary embodiments, the transmission module may be the same or similar to the transmission module 314 as illustrated in FIG. 3.

At step S524, the data contract along with the attached partial digital data contract compliance certificate and the digital variance certificate may be received by a receiving module embedded within a computing device at a data consumer side. According to exemplary embodiments, the receiving module may be the same or similar to the receiving module 303′ as illustrated in FIG. 3 and the computing device may be the same or similar to the computing device 301′ as illustrated in FIG. 3.

At step S526, the data contract may be automatically processed by a processing module at a data consumer side for enforcement without requiring any need to contact the data provider. According to exemplary embodiments, the processing module may be the same or similar to the processing module 320′ as illustrated in FIG. 3.

According to exemplary embodiments, in the process 500, step S506 of generating a digital data contract compliance certificate may further include: cryptographically signing, with the computing device, the digital data contract compliance certificate with an authorized data provider's private key, the digital data contract compliance certificate comprising an indication that the authorized data provider is an individual authorized to take responsibility that all validation rules in the data contract complies with the predefined compliance rules.

According to exemplary embodiments, in the process 500, step S506 of generating a partial digital data contract compliance certificate may further include: cryptographically signing, with the computing device, the partial digital data contract compliance certificate with an authorized data provider's private key, the partial digital data contract compliance certificate comprising an indication that the authorized data provider is an individual authorized to take responsibility that one or more validation rules in the data contract fails to comply with the predefined compliance rules.

According to exemplary embodiments, in the process 500, step S506 of generating a digital variance certificate may further include: cryptographically signing, with the computing device, each digital variance certificate with an authorized data provider's private key; each digital variance certificate comprising an indication that the authorized data provider is an individual authorized to take responsibility for data contract variances.

According to exemplary embodiments, in the process 500, step S518 of authorizing processing of the data contract in spite of one or more failed validation rules may further include: cryptographically signing, with the computing device, each digital variance certificate with an authorized data provider's private key, the digital variance certificate comprising an indication that the authorized data provider is an individual authorized to take responsibility for authorizing processing of the data contract in spite of one or more failed validation rules.

According to exemplary embodiments, the computing device 301 may include a memory (e.g., a memory 106 as illustrated in FIG. 1) which may be a non-transitory computer readable medium that may be configured to store instructions for implementing DCMM 302 for automatic enforcement of a data contract. The computing device 301 may also include a medium reader (e.g., a medium reader 112 as illustrated in FIG. 1) which may be configured to read any one or more sets of instructions, e.g., software, from any of the memories described herein. The instructions, when executed by a processor embedded within the DCMM 302 or within the computing device 301 may be used to perform one or more of the methods and processes as described herein. In a particular embodiment, the instructions may reside completely, or at least partially, within the memory 106, the medium reader 112, and/or the processor 104 (see FIG. 1) during execution by the computing device 301.

For example, the instructions, when executed, may cause the processor 104 to perform the following: receiving, by a computing device, a data contract that exists between a data provider and a data consumer, the data contract including one or more validation rules; determining, by the computing device, whether the one or more validation rules in the data contract complies, with predefined compliance rules; responsive to determining that all validation rules in the data contract comply with the predefined compliance rules, causing the processor to perform the following: generating a digital data contract compliance certificate; digitally attaching the digital data contract compliance certificate with the data contract; and transmitting the data contract along with the attached digital data contract compliance certificate to an output device for automatic processing for enforcement of the data contract: and responsive to determining that one or more validation rules in the data contract fails to comply with the predefined compliance rules, causing the processor to perform the following: generating a partial digital data contract compliance certificate; generating a digital variance certificate for each faded validation rule that explains the reason for failing; authorizing processing of the data contract in spite of one or more failed validation rules; digitally attaching the partial digital data contract compliance certificate and the digital variance certificate with the data contract; and transmitting the data contract along with the partial digital data contract compliance certificate and the digital variance certificate to an output device for automatic processing for enforcement of the data contract.

According to exemplary embodiments, in generating a digital data contract compliance certificate, the instructions, when executed, may cause the processor 104 to further perform: indicating that the authorized data provider is an individual authorized to take responsibility that all validation rules in the data contract comply with the predefined compliance rules. According to exemplary embodiments, such indication may optionally be provided by cryptographically signing, with the computing device, the digital data contract compliance certificate with an authorized data provider's private key, but the disclosure is not limited thereto.

According to exemplary embodiments, in generating a partial digital data contract compliance certificate, the instructions, when executed, may cause the processor 104 to further perform: indicating that the authorized data provider is an individual authorized to take responsibility that the authorized data provider is an individual authorized to take responsibility that one or more validation rules in the data contract fails to comply with the predefined compliance rules. According to exemplary embodiments, such indication may optionally be provided by cryptographically signing, with the computing device, the partial digital data contract compliance certificate with an authorized data provider's private key, but the disclosure is not limited thereto.

According to exemplary embodiments, in generating a digital variance certificate, the instructions, when executed, may cause the processor 104 to further perform: indicating that the authorized data provider is an individual authorized to take responsibility for data contract variances. According to exemplary embodiments, such indication may optionally be provided by cryptographically signing, with the computing device, each digital variance certificate with an authorized data provider's private key; but the disclosure is not limited thereto.

According to exemplary embodiments, in authorizing processing of the data contract in spite of one or more failed validation rules, the instructions, when executed, may cause the processor 104 to further perform: indicating that the authorized data provider is an individual authorized to take responsibility for authorizing processing of the data contract in spite of one or more failed validation rules. According to exemplary embodiments, such indication may optionally be provided by cryptographically signing, with the computing device, each digital variance certificate with an authorized data provider's private key, but the disclosure is not limited thereto.

According to exemplary embodiments, the output device may be utilized by the data consumer, and the instructions, when executed, may cause the processor 104 to further perform: receiving, by the output device, the data contract along with the attached digital data contract compliance certificate and automatically processing the data contract for enforcement of the data contract without requiring any need to contact the data provider.

According to exemplary embodiments, the output device may be utilized by a data consumer, and the instructions, when executed, may cause the processor 104 to further perform: receiving, by the output device, the data contract along with the partial digital data contract compliance certificate and the digital variance certificate; and automatically processing the data contract for enforcement of the data contract without requiring any need to contact the data provider.

Thus, the exemplary embodiments disclosed herein with reference to FIGS. 1-5 may provide platforms for implementing a data contract management module which may automatically handle and process a vast amount of data in a quick and expedited manner and manage quality of data received, thereby significantly increasing data processing speed of a processor and significantly reducing lapse time that may be necessary to manage data quality of data that is flowing between a plurality of computing devices, but the disclosure is not limited thereto. For example, the various aspects, embodiments, and/or specific features or sub-components of the exemplary embodiments disclosed herein with reference to FIGS. 1-5, may provide, among other features, various systems, servers, devices, methods, media, programs, and platforms for implementing a data contract management module for automatic enforcement of a data contract to significantly increase data processing speed of a processor and significantly reduce lapse time that may be necessary to manage data quality of data that is flowing between a plurality of computing devices thereby improving computer functionalities of a graphical user interface (GUI), significantly reducing utilization of computer resources, and reducing utilization of memory spaces thereby maintaining optimum memory spaces for other computer processing algorithms, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium. or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media. in which data or instructions may he stored.

Although the present application describes specific embodiments which may be implemented as computer programs or code segments in computer-readable media, it is to be understood. that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope a the present disclosure. Thus, to the maximum extent allowed by law, the scope of the present disclosure is to be determined by the broadest permissible interpretation of the following claims and their equivalents, and shall not be restricted or limited by the, foregoing detailed description.

What is claimed is:

1. A method for implementing a data contract management module for automatic enforcement of a data contract by utilizing one or more processors and one or more memories, the method comprising:
receiving, by a computing device, a data contract that exists between a data provider and a data consumer, the data contract including one or more validation rules;
determining, by the computing device, whether the one or more validation rules in the data contract complies with predefined compliance rules;
responsive to determining that all validation rules in the data contract comply with the predefined compliance rules, causing a processor to perform the following;
generating a digital data contract compliance certificate;
digitally attaching the digital data contract compliance certificate with the data contract; and
transmitting the data contract along with the attached digital data contract compliance certificate to an output device for automatic processing, for enforcement of the data contract; and
responsive to determining that one or more validation rules in the data contract fails to comply with the predefined compliance rules, causing the processor to perform. the following:
generating a partial digital data contract compliance certificate;
generating a digital variance certificate for each failed validation rule that explains reason for failing;
authorizing processing of the data contract in spite of one or more failed validation rules;
digitally attaching the partial digital data contract compliance certificate and the digital variance certificate with the data contract; and
transmitting the data contract along with the partial digital data contract compliance certificate and the digital variance certificate to an output device for automatic processing for enforcement of the data contract.

2. The method according to claim 1, wherein generating a digital data contract compliance certificate further comprises:
cryptographically signing, with the computing device, the digital data contract compliance certificate with an authorized data provider's private key, the digital data contract compliance certificate comprising an indication that the authorized data provider is an individual authorized to take responsibility that all validation rules in the data contract comply with the predefined compliance rules.

3. The method according to claim 1, wherein generating a partial digital data contract compliance certificate further comprises:
cryptographically signing, with the computing device, the partial digital data contract compliance certificate with an authorized data provider's private key, the partial digital data. contract compliance certificate comprising an indication that the authorized data provider is an individual authorized to take responsibility that one or more validation rules in the data. contract fails to comply with. the predefined compliance rules.

4. The method according to claim 1, wherein generating a digital variance certificate further comprises:
cryptographically signing, with the computing device, each digital variance certificate with an authorized data provider's private key, each digital variance certificate comprising an indication that the authorized data provider is an individual authorized to take responsibility for data contract variances.

5. The method according to claim 1, wherein authorizing processing of the data contract in spite of one or more failed validation rules further comprises:
cryptographically signing, with the computing device, each digital variance certificate with an authorized data provider's private key, the digital variance certificate comprising an indication that the authorized data provider is an individual authorized to take responsibility for authorizing processing of the data contract in spite of one or more failed validation rules.

6. The method according to claim 1, wherein the digital data contract compliance certificate indicates a status of a group of validations which constitute the digital data contract.

7. The method according to claim 1, wherein the output device is utilized by the data consumer, the method further comprising:
receiving, by the output device, the data contract along with the attached digital data contract compliance certificate; and
automatically processing the data contract for enforcement of the data contract without requiring any need to contact the data provider.

8. The method according to claim 1, wherein the output device is utilized by the data consumer, the method further comprising:
receiving, by the output device, the data contract along with the partial digital data contract compliance certificate and the digital variance certificate; and
automatically processing the data contract for enforcement of the data contract without requiring any need to contact the data provider,

9. A system for implementing a data contract management module for automatic enforcement of a data contract, the system comprising:
repository that digitally stores a data contract that exists between a data provider and a data consumer, the data contract including one or more validation rules; and
a processor coupled to the repository via a communication network, wherein the processor is configured to:
determine whether the one or more validation rules in the data contract complies with predefined compliance rules;
responsive to determining that all validation rules in the data contract comply with the predefined compliance rules, the processor is further configured to:
generate a digital data contract compliance certificate;
digitally attach the digital data contract compliance certificate with the data contract; and
transmit the data contract along with the attached digital data contract compliance certificate to an output device for automatic processing for enforcement of the data contract; and
responsive to determining that one or more validation rules in the data contract fails to comply with the predefined compliance rules, the processor is further configured to:
generate a partial digital data contract compliance certificate;
generate a digital variance certificate for each failed validation rule that explains the reason for failing;
authorize processing of the data contract in spite of one or more failed validation rules;
digitally attach the partial digital data contract compliance certificate and the digital variance certificate with the data contract; and
transmit the data contract along with the partial digital data contract compliance certificate and the digital variance certificate to an output device for automatic processing for enforcement of the data contract.

10. The system according to claim 9, wherein in generating a digital data contract compliance certificate, the processor is further configured to:
cause the computing device to receive cryptographic signature on the digital data contract compliance certificate with an authorized data provider's private key, the digital data contract compliance certificate comprising an indication that the authorized data provider is an individual authorized to take responsibility that all validation rules in the data contract comply with the predefined compliance rules.

11. The system according to claim 9, wherein in generating a partial digital data contract compliance certificate, the processor is further configured to:
cause the computing device to receive cryptographic signature on die partial digital data contract compliance certificate with an authorized data provider's private key, the partial digital data contract compliance certificate comprising an indication that die authorized data provider is an individual authorized to take responsibility that one or more validation rules in the data contract fails to comply with the predefined compliance rules.

12. The system according to claim 9, wherein in generating a digital variance certificate, the processor is further configured to;
cause the computing device to receive cryptographic signature on each digital variance certificate with an authorized data provider's private key, each digital variance certificate comprising an indication that the authorized data provider is an individual authorized to take responsibility for data contract variances.

13. The system according to claim 9, wherein in authorizing processing of the data contract in spite of one or more failed validation rules, the processor is further configured to:
cause the computing device to receive cryptographic signature on each digital variance certificate with an authorized data provider's private key, the digital variance certificate comprising an indication that the authorized data provider is an individual authorized to take responsibility for authorizing processing of the data contract in spite of one or more failed validation rules.

14. The system according to claim 9, wherein the digital data contract compliance certificate indicates a status of a group of validations which constitute the digital data contract.

15. The system according to claim 9, wherein the output device is utilized by the data consumer, the processor is further configured to:
cause the output device to receive the data contract along with the attached digital data contract compliance certificate; and
automatically process the data contract for enforcement of the data contract without requiring any need to contact the data provider.

16. The system according to claim 9, wherein the output device is utilized by the data consumer, the processor is further configured to:
cause the output device to receive the data contract along with the partial digital data contract compliance certificate and the digital variance certificate; and
automatically process the data contract for enforcement of the data contract without requiring any need to contact the data provider.

17. A non-transitory computer readable medium configured to store instructions for implementing a data contract management module for automatic enforcement of a data contract, wherein, when executed, the instructions cause a processor to perform the following:
receiving, by a computing device, a data contract that exists between a data provider and a data consumer, the data contract including one or more validation rules;
determining, by the computing device, whether the one or inure validation rules in the data contract complies with predefined compliance rules;
responsive to determining that all validation rules in the data contract comply with the predefined compliance rules, causing the processor to perform the following:
generating a digital data contract compliance certificate;
digitally attaching the digital data contract compliance certificate with the data contract; and
transmitting the data contract along with the attached digital data contract compliance certificate to an output device for automatic processing for enforcement of the data contract; and
responsive to determining that one or more validation rules in the data contract fails to comply with the predefined compliance rules, causing the processor to perform the following:
generating a partial digital data contract compliance certificate;
generating a digital variance certificate for each failed validation rule that explains the reason for failing;
authorizing processing of the data contract in spite of one or more failed validation rules;
digitally attaching the partial digital data contract compliance certificate and the digital variance certificate with the data contract; and
transmitting the data contract along with the partial digital data contract compliance certificate and the digital variance certificate to an output device for automatic processing for enforcement of the data contract.

18. The non-transitory computer readable medium according to claim 17, wherein the output device is utilized by the data consumer, and wherein the instructions, when executed, causes the processor to perform the following:
receiving, by die output device, the data contract along with the attached digital data contract compliance certificate; and
automatically processing die data contract for enforcement of the data contract without requiring any need to contact the data provider.

19. The non-transitory computer readable medium according to claim 17, wherein the output device is utilized by the data consumer, and wherein the instructions, when executed, causes the processor to perform the following:
receiving, by the output device, the data contract along with the partial digital data contract compliance certificate and the digital variance certificate; and
automatically processing the data contract for enforcement of the data contract without requiring any need to contact the data provider.

20. The non-transitory computer readable medium according to claim 17, wherein in generating a digital data contract compliance certificate, the instructions, when executed, causes the processor to perform the following:
causing the computing device to receive cryptographic signature on the digital data contract compliance certificate with an authorized data provider's private key, the digital data contract compliance certificate comprising an indication that the authorized data provider is an individual authorized to take responsibility that all validation rules in the data contract comply with the predefined compliance rules.
